(19) United States
(12) Patent Application Publication
(10) Pub. No.: US 2012/0124122 A1
(43) Pub. Date: May 17, 2012

(54) SHARING AFFECT ACROSS A SOCIAL NETWORK

(76) Inventors: Rana el Kaliouby, Newton, MA (US); Richard Scott Sadowsky, Sturbridge, MA (US); Oliver Orion Wilder-Smith, Holliston, MA (US)

(21) Appl. No.: 13/297,342

(22) Filed: Nov. 16, 2011

Related U.S. Application Data
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/549,560, filed on Oct. 20, 2011.

(51) Int. Cl. G06F 15/16

(52) U.S. Cl. 709/202

(57) ABSTRACT

Mental state information is collected from an individual through video capture or capture of sensor information. The sensor information can be of electrodermal activity, accelerometer readings, skin temperature, or other characteristics. The mental state information may be collected over a period of time and analyzed to determine a mood of the individual. An individual may share their mental state information across a social network. The individual may be asked to elect whether to share their mental state information before it is shared.

### RELATED APPLICATIONS

This application claims the benefit of U.S. provisional patent applications “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, “Baseline Face Analysis” Ser. No. 61/467,209, filed Mar. 24, 2011, and “Mental State Analysis of Voters” Ser. No. 61/549,560, filed Oct. 20, 2011. Each of the foregoing applications is hereby incorporated by reference in its entirety.

### FIELD OF INVENTION

This application relates generally to analysis of mental states and more particularly to sharing affect data across a social network.

### BACKGROUND

People spend a tremendous amount of time on the internet, much of that including the viewing and interacting with web pages including pages for social networks. The evaluation of mental states is key to understanding individuals and the way in which they react to the world around them and this world more and more include the virtual world. Mental states run a broad gamut from happiness to sadness, from contentedness to worry, from excitement to calmness, as well as numerous others. These mental states are experienced in response to everyday events such as frustration during a traffic jam, boredom while standing in line, impatience while waiting for a cup of coffee, and even as people interact with their computers and the internet. Individuals may become rather perceptive and empathetic based on evaluating and understanding others' mental states but automated evaluation of mental states is far more challenging. An empathetic person may perceive another's being anxious or joyful and respond accordingly. The ability and means by which one person perceives another's emotional state may be quite difficult to summarize and has often been communicated as having a “gut feel.”

Many mental states, such as confusion, concentration, and worry, may be identified to aid in the understanding of an individual or group of people. People can collectively respond with fear or anxiety, such as after witnessing a catastrophe. Likewise, people can collectively respond with happy enthusiasm, such as when their sports team obtains a victory. Certain facial expressions and head gestures may be used to identify a mental state that a person is experiencing. Limited automation has been performed in the evaluation of mental states based on facial expressions. Certain physiological conditions may provide telling indications of a person's state of mind and have been used in a crude fashion as in polygraph tests.

### SUMMARY

Analysis of people, as they interact with the internet and various media, may be performed by gathering mental states through evaluation of facial expressions, head gestures, and physiological conditions. Some of the mental state analysis may then be shared across a social network. A computer implemented method for communicating mental states is disclosed comprising: collecting mental state data of an individual; analyzing the mental state data to produce mental state information; and sharing the mental state information across a social network. The method may further comprise electing, by the individual, to share the mental state information. The method may further comprise presenting the mental state information to the individual, prior to the electing. The mental state data may be collected over a period of time and the mental state information that is shared is a reflection of a mood for the individual. The mood may include one of a group comprising frustration, confusion, disappointment, hesitation, cognitive overload, focusing, being engaged, attending, boredom, exploration, confidence, trust, delight, and satisfaction. The sharing may include posting mental state information to a social network web page. The method may further comprise uploading the mental state information to a server. The method may further comprise distributing the mental state information across a computer network. The mental state data may include one of a group comprising physiological data, facial data, and actigraphy data. A webcam may be used to capture one or more of the facial data and the physiological data. The facial data may include information on one or more of a group comprising facial expressions, action units, head gestures, smiles, brow furrows, squints, lowered eyebrows, raised eyebrows, and attention. The physiological data may include one or more of electrodermal activity, heart rate, heart rate variability, skin temperature, and respiration. The method may further comprise inferring of mental states based on the mental state data which was collected. The method may further comprise identifying similar mental states within the social network. The mental states may include one of a group comprising frustration, confusion, disappointment, hesitation, cognitive overload, focusing, being engaged, attending, boredom, exploration, confidence, trust, delight, and satisfaction. The method may further comprise communicating an image of the individual with the mental state information that is being shared. The image of the individual may be from a peak time of mental state activity. The image may include a video. The method may further comprise restricting distribution of the mental state information to a subset of the social network. The method may further comprise sharing aggregated mental state information across the social network. The mental state data may be collected as the individual interacts with a web-enabled application. The web-enabled application may be one of a group comprising a landing page, a checkout page, a webpage, a website, a video on the web-enabled application, a game on the web-enabled application, a trailer, a movie, an advertisement, and a virtual world. The method may further comprise forwarding a reference to the web-enabled application as a part of the sharing of the mental state information. The reference may include a URL and a timestamp. The forwarding may include an image of material from the web-enabled application. The forwarding may include a video of material from the web-enabled application. The sharing may be part of a rating system for the web-enabled application. The mental state data may be collected using a biosensor.

In some embodiments, a computer program product embodied in a non-transitory computer readable medium for communicating mental states may comprise: code for collecting mental state data of an individual; code for analyzing the mental state data to produce mental state information; code for electing, by the individual, to share the mental state information; and code for sharing the mental state information across a social network. In embodiments, a system for sharing mental states may comprise: a memory for storing instructions; one or more processors attached to the memory wherein the one or more processors are configured to: collect mental state data of an individual; analyze the mental state data to produce mental state information; receive an instruction, from the individual, to elect to share the mental state information; and share the mental state information across a social network.

In some embodiments, a computer implemented method for communicating mental states comprises: receiving mental state information on of an individual; inferring mental states for the individual based on the mental state information which was received; and sharing the mental states which were inferred across a social network.

Various features, aspects, and advantages of numerous embodiments will become more apparent from the following description.

### BRIEF DESCRIPTION OF THE DRAWINGS

The following detailed description of certain embodiments may be understood by reference to the following figures wherein:

FIG. 1 is a diagram of a webcam view screen.

FIG. 2 is diagram of an analytics chart for affect data.

FIG. 3 is a flow diagram for sharing mental state information

FIG. 4 is a flow diagram for sharing across a social network

FIG. 5 is a diagram of for capturing facial response to rendering.

FIG. 6 is a diagram representing physiological analysis.

FIG. 7 is a diagram of heart related sensing.

FIG. 8 is a graphical representation of mental state analysis.

FIG. 9 is a diagram of a web page to elect sharing.

FIG. 10 is an example social network page content.

FIG. 11 is a system diagram with sharing across a social network.

### DETAILED DESCRIPTION

The present disclosure provides a description of various methods and systems for analyzing people's mental states as they interact with websites, web-enabled applications, and/or other features on the internet with the result being shared across a social network. Social networking has become more and more a part of everyday life with a society which constantly connected through the Internet. Communication is accomplished by email, postings, texting, short messages, and the like but communication of emotions has remained a challenge. By performing mental state analysis and then communicating those mental states across a social network, virtual communication becomes much more attuned to the person. The communication is not limited to explicit postings and instead allows communication of emotion. Mental states may include emotional states and/or cognitive states. Examples of emotional states include happiness or sadness. Examples of cognitive states include concentration or confusion. Observing, capturing, and analyzing these mental states can yield significant information about people's reactions that far exceed current capabilities in website type analytics.

A challenge solved by this disclosure is the collection and analysis of mental states of an individual to produce mental state information that may be shared across a social network. Mental state data may be collected from an individual while performing specific tasks or over longer periods of time. Mental state data may include physiological data from sensors, facial data from a webcam, or actigraphy data. The mental state data may be analyzed to create mental state information. Mental state information may include moods, other mental states, mental state data or mental state information derived or inferred from mental state data. Mental states of the individual may include frustration, confusion, disappointment, hesitation, cognitive overload, focusing, being engaged, attending, boredom, exploration, confidence, trust, delight, and satisfaction or other emotions or cognitive states. Mental state information may relate to a specific stimulus, such as reacting to a web-enabled application, or may be a mood, which may relate to a longer period of time and may indicate, for example, a mental state for a day.

The individual may be given an opportunity to share their mental state with others. If the individual opts-in for sharing, their mental state may be shared over a social network. The mental state may be shared over a social network by posting mood information on a social media or social network web page. The mental state shared may be an overall mood or may be a reaction to a specific stimulus. If the mental state is a reaction to a specific stimulus, a reference to the stimulus, such as a web-enabled application, may be shared. The reference may include a uniform reference locator (URL) and/or a timestamp. An image of the individual corresponding to their mood may be posted along with the mental state. Other individuals on the social network having a similar mental state may be identified to the individual. And in some cases the mental states of an individual's contacts on the social network may be aggregated and shared on the social network.

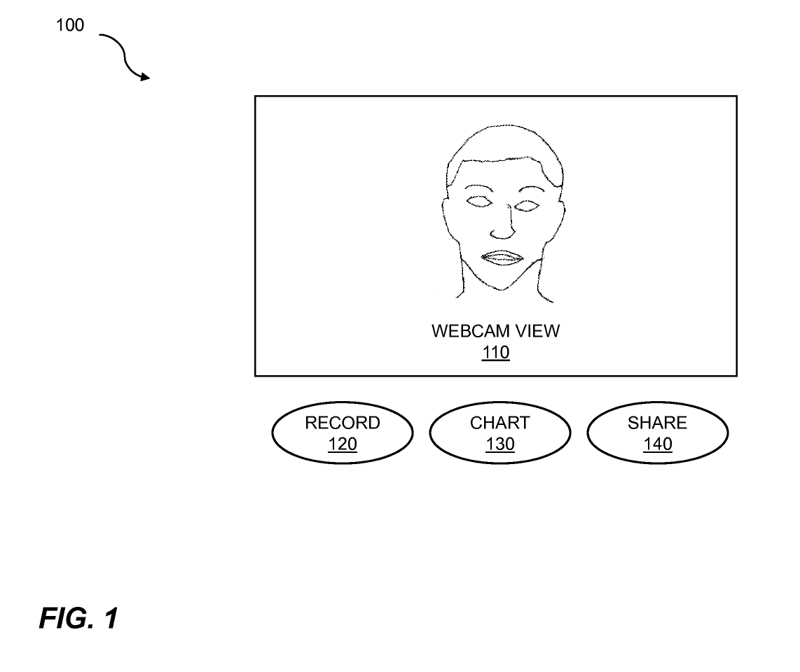

FIG. 1 is a diagram of a webcam view screen. A window 100 may contain a view and several buttons. A webcam view 110 may include a view of an individual. The webcam view 110 may be obtained by a webcam or some other camera device attached to a computer. The view of the individual may show a video of the person's head, the whole person, or some portion of the person. A person's head may be viewed where the face is shown and facial expressions may be observed. The facial expressions may include facial actions and head gestures. Facial data may be observed including facial actions and head gestures used to infer mental states. Further, the observed data may include information on hand gestures or body language and body movements such as visible fidgets. In various embodiments these movements may be captured by cameras or by sensor readings. Facial data may include the tilting the head to the side, leaning forward, a smile, a frown, as well as many other gestures or expressions. The facial data may include information such as facial expressions, action units, head gestures, smiles, brow furrows, squints, lowered eyebrows, raised eyebrows, and attention. The webcam observations may include a blink rate for the eyes. For example a reduced blink rate may indicate significant engagement in what is being observed. The webcam observations may also capture physiological information. Observations via the webcam may be accomplished while an individual is going through their normal tasks while using a computer. Observations may also be performed while specific items are being viewed, or interacted with, such as a web-enabled application, a video on a web-enabled application, a game on a web-enabled application, and a virtual world. In some embodiments, the webcam view 110 may become smaller, may become an icon, or may disappear, while the individual is interacting with a web-enabled application. In some embodiments, observations are performed while normal events of the day transpire.

A record button 120 may be included to record the webcam view 110. The record button 120 may be part of the “opting in” by the individual in the webcam view 110 where permission is obtained for observing mental state information and sharing this information. The record button 120 may be moused over to explain the purpose of the record button 120. The record button 120 may be clicked in order to start the recording. The record button may be clicked again to stop the recording. In some embodiments, recording may be accomplished based on sensing context. Recording can automatically begin as viewing or interaction begins with a specific web-enabled application. Recording can automatically end at a specific point in time or as a web-enabled application reaches it's ending point. One such example is a series of video trailers that may be viewed. Recording of the webcam view can begin and end with the start and termination of each video trailer. In embodiments, permission may be granted for recording of the webcam view for certain contexts of operation. Further, the context may be recorded as well as the webcam view.

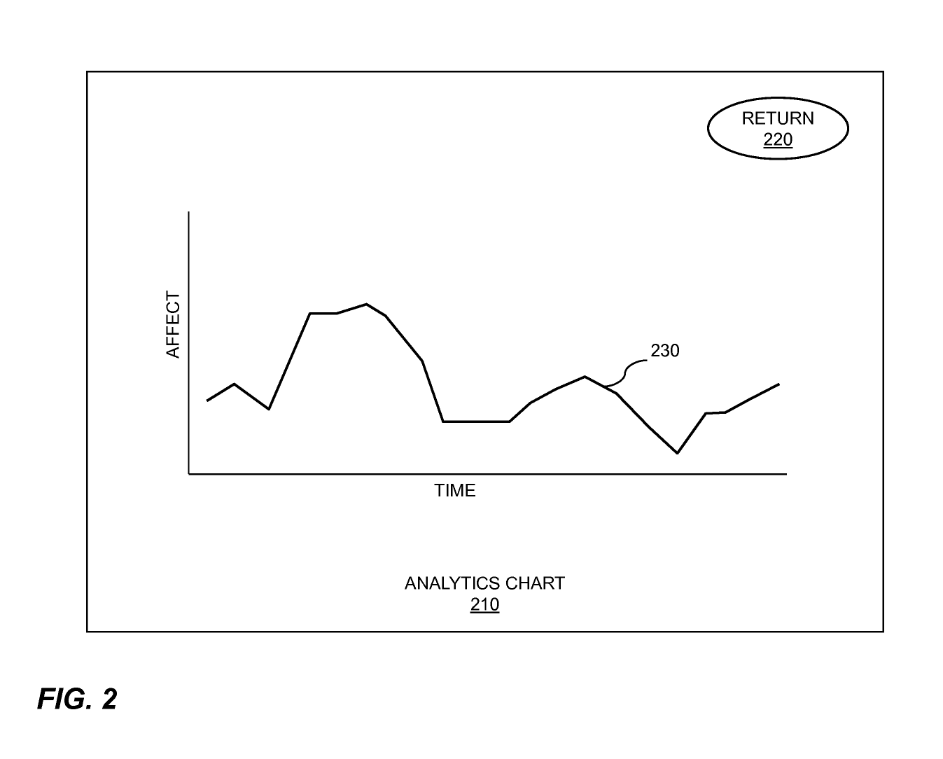

A chart button 130 may be used to display analytics of the information collected while the webcam was recording. The chart button 130 may be moused over to explain the purpose of the button. The chart button 130 may be clicked on to display a chart such as that shown in FIG. 2. The chart button 130 may be clicked before the sharing of the mental state information so that a person can determine whether he or she wants to share their mental state information with others. A share button 140 may be used for sharing the mental state information collected when the record button 120 is clicked. The share button 140 may be part of the “opting in” process of sharing mental state information with others. The share button 140 may be moused over to explain the purpose of the button. The share button 140 may be clicked to share mental state information with an individual, a group of people, or a social network. By clicking the share button 140 the mental state information may be communicated by email, may be posted to Facebook™, may be shared by Twitter™, or other social networking site. Sharing of mental state information may be a one-time occurrence or may be continuous. Once sharing is initiated, mental state information may be posted regularly to a social networking site. In this manner, a person's mental state information may be broadcast to their social network. Sharing may also communicate a reference to a web-enabled application or the web-enabled application itself. The reference to the web-enabled application could be, for example, a web-page link. Based on this sharing the individual could communicate what they viewed and their mental states while viewing it. The individual could further request an elicited response from the individual or people with whom they are sharing their mental states.

FIG. 2 is a diagram of an analytics chart 210 for affect data. The analytics chart 210 may include “time” on the x-axis and “affect” on the y-axis. A graph 230 may be shown that describes the affect data over time. The time period shown may be for a recent period of time where the individual was performing a variety of tasks or for a specific task such as where the mental state data that is collected as the individual interacts with a web-enabled application. The affect data may be as simple as a head gesture, such as indicating when an individual is leaning toward the screen. Leaning toward the screen can be an indicator of greater interest in what is being viewed on the screen. Affect data could also be an action unit used in mental state analysis. The action units may include the raising of an eyebrow, raising of both eyebrows, a twitch of a smile, a furrowing of the eye brows, flaring of nostrils, squinting of the eyes, and many other possibilities. These action units may be automatically detected by a computer system analyzing the video. Affect data could also be some mental state evaluation. For example a graph could show positive or negative reactions. In some embodiments, a color could be used instead of a graph. For instance green could denote a positive reaction while red could denote a negative reaction. Affect data could also be graphically displayed for a more specific mental state evaluation. For example, a single mental state could be graphed. Some of the mental states which could be graphed include frustration, confusion, disappointment, hesitation, cognitive overload, focusing, being engaged, attending, boredom, exploration, confidence, trust, delight, and satisfaction. In some embodiments, a smile track may be displayed which provides a line for each occurrence of a smile. As a smile is longer and more pronounced the line for the smile can be darker and more pronounced. Just as a chart button 130 can be selected from FIG. 1, a return button 220 can be selected from the window displayed in FIG. 2. The return button 220 may, in various embodiments, return the window to showing a webcam view, the previous web-enabled application, or the like.

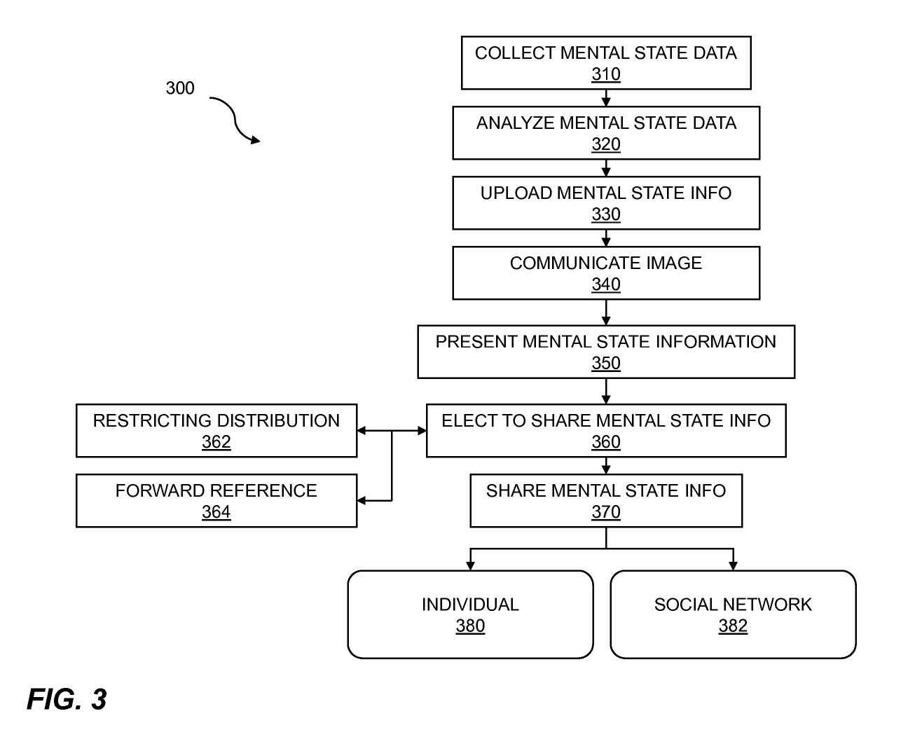

FIG. 3 is a flowchart for sharing mental state information. A flow 300 may begin with collecting mental state data 310 of an individual. The mental state data may include collecting action units, collecting facial expressions, and the like. Physiological data may be obtained from video observations of a person. For example heart rate, heart rate variability, autonomic activity, respiration, and perspiration may be observed from video capture. Alternatively, in some embodiments, a biosensor may be used to capture physiological information and may also be used to capture accelerometer readings. Permission may be requested and obtained prior to the collection of mental state data 310. The mental state data may be collected by a client computer system.

The flow 300 may continue with analyzing the mental state data 320 to produce mental state information. While mental state data may be raw data such as heart rate, mental state information may include information derived from the raw data. The mental state information may include the mental state data. The mental state information may include valence and arousal. The mental state information may include the mental states experienced by the individual. Some embodiments may include inferring of mental states based on the mental state data which was collected.

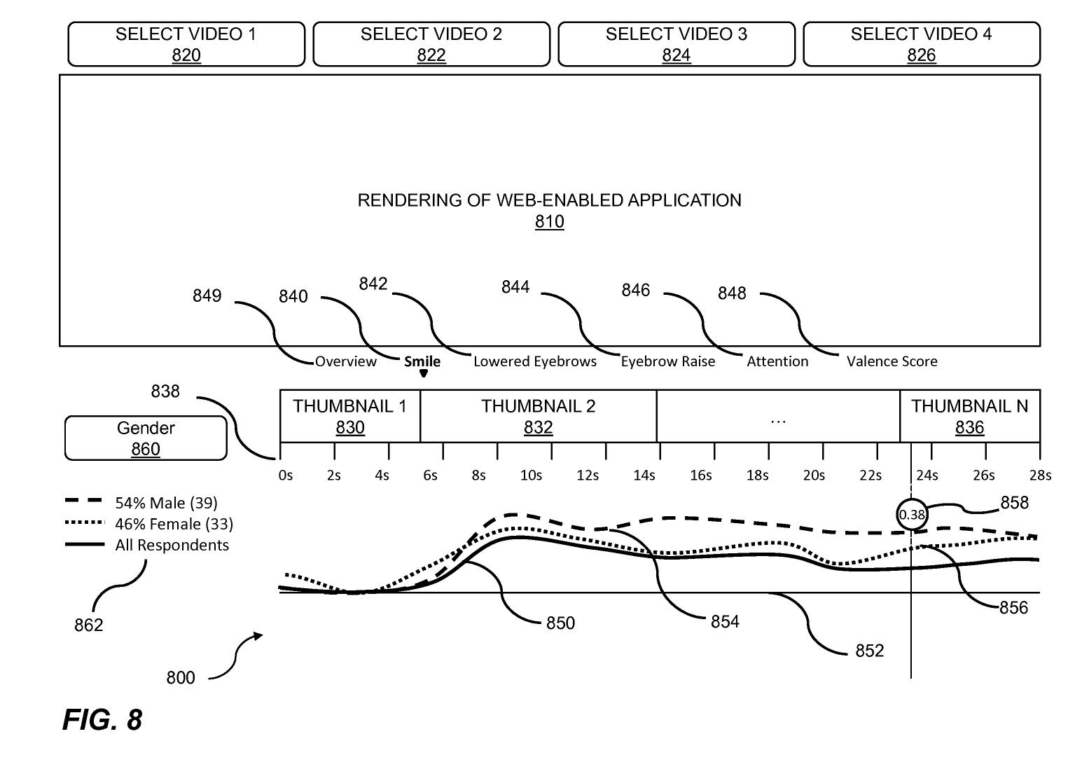

The flow 300 may continue with uploading mental state information 330 to a server. The server may be remote from the user and may be a host to data used by a social network, but in other embodiments the server may be separate from the social network's computer system and be used for storage for mental state information as well as other functionality. In some cases, an image may be communicated 340 to the server with the mental state information. The image may be of the individual as the mental state data was being collected and may be representative of the mental state information. In other embodiments, the image may be captured or identified in advance to represent a particular mental state. The flow 300 may continue with presenting the mental state information to the individual 350, prior to electing to share. Some embodiments may allow the user to make the election before the presenting. In some embodiments the mental state data, the mental state information, or a subset of the mental state information may be presented to the individual. In some embodiments there may be no presentation. The mental state information may be presented to the individual in various ways such as a textual description of a mood, an image obtained of the individual or from the individual, a graph such as shown in FIG. 2 or FIG. 8, or any other way of conveying the mental state information.

The flow 300 may continue with electing, by the individual, to share the mental state information 360 or mental states. The individual may choose to restrict distribution 362 of the mental state information. The individual may choose to share all or a portion of the mental state data and mental state information. The individual may choose to share with an individual, a group of people, or across a social network, such as restricting distribution of the mental state information to a subset of a social network. In embodiments, mental state information may be shared to others whom the network may recommend. In some embodiments, a reference to a web-enabled application may be forwarded 364 to the selected group or subgroup. In some embodiments, the forwarding is accomplished by selecting a “like” type button on a web page. The reference may include information on a video, trailer, e-book, web site, movie, advertisement, television show, streamed video clip, video game, computer game, or the like. The reference may include a timestamp, page number, web page URL, or the like to identify a portion of the reference. The forwarding may include a Twitter™ message, text, SMS, or the like. A URL or short-URL may be included when the reference is forwarded 364. The flow 300 may continue with sharing mental state information 370. The sharing may include transmission of data from an individual's client computer to a server which retains mental state information. The sharing may include a web link, a web-enabled application reference, or a web-enabled application. The mental state information may be communicated from the server to an individual 380. Alternatively, there may be peer-to-peer sharing of mental state information from a first individual to a second individual. Some embodiments may include sharing the mental state information across a social network 382. Mental states may be communicated via Facebook™, LinkedIn™, MySpace™, Twitter™, Google+™, or other social networking site.

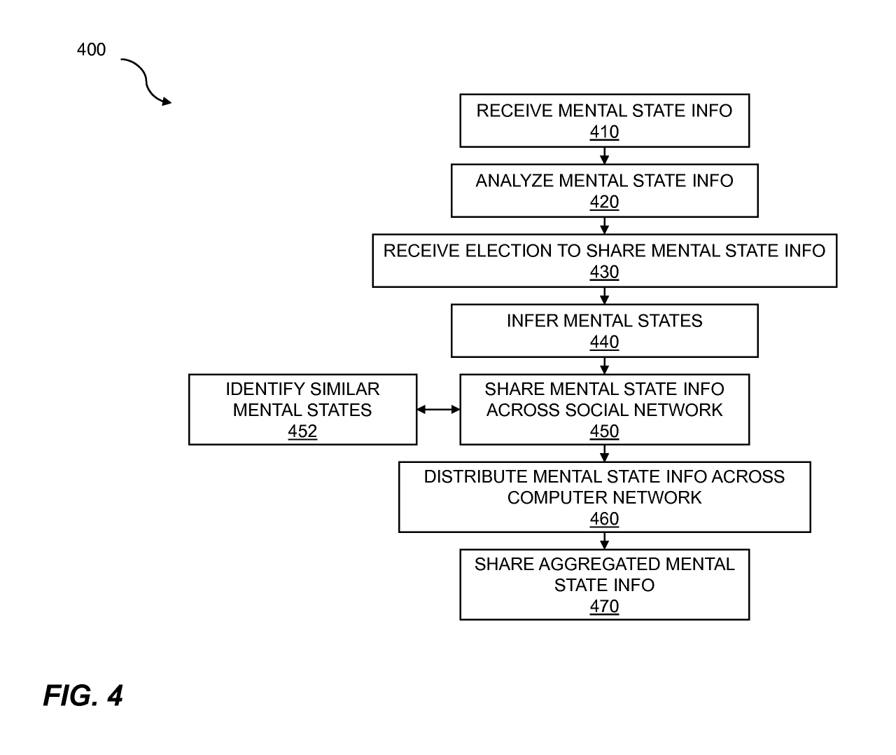

FIG. 4 is a flow diagram for sharing across a social network. The flow 400 describes a computer implemented method for sharing mental states and may represent activity from a server perspective. The flow 400 may begin with receiving mental state data 410 on an individual. The mental state information may be collected as described for flow 300, or may be received from a client computer that collected the mental state information. In some embodiments, the mental state information may be analyzed 420 to extract further information such as facial expressions, action units, head gestures, smiles, brow furrows, squints, lowered eyebrows, raised eyebrows, or attention. An election to share mental state information may be received 430 from the individual to indicate their desire to share the mental state information with others. The election may come from a user selecting a button on a screen of a web-enabled application to opt-in to sharing mental state information.

The flow 400 continues with inferring mental states 440 for the individual based on the mental state information which was received. The mental states that may be inferred include frustration, confusion, disappointment, hesitation, cognitive overload, focusing, being engaged, attending, boredom, exploration, confidence, trust, delight, and satisfaction. In some embodiments, collective mental states may be inferred for a group of people. The flow 400 continues with sharing the mental states which were inferred across a social network 450. Some embodiments may include identifying similar mental states within the social network 452. The group of people that may be searched to identify similar mental states may vary according to the embodiment. Some embodiments may only search an individual's direct contact list while others may search an extended contact list such as including the contacts of the individual's contacts, or an even more extended group going out several levels of contact's contacts. In other embodiments, only a group that has been specifically created to share mental state information may be searched while other embodiments may search outside of the individual's extended network to help identify people that may be interesting to the individual and may be potential new contacts.

Multiple individuals can have their mental states collected and their mental state information distributed across a computer network 460 for various purposes. These mental states can be aggregated together and the combined mental state evaluation can be posted or propagated to others. A webmaster may collect affect data and mental state information. This data and/or information can be tagged to the website controlled by the webmaster and therefore the mental states can be associated with the web-enabled application. Further, aggregated responses can be used to evaluate the viral potential of a web-enabled application, such as a video or game. The aggregation may take various forms in various embodiments but examples may include creating an aggregate mood of an individual's contact on a social network, creating aggregate mental state information of the people that have viewed a movie trailer, tabulating a percentage of a particular group having a particular mental state, or any other method of aggregating mental state information. Flow 400 may finish by sharing aggregated mental state information across a social network 470.

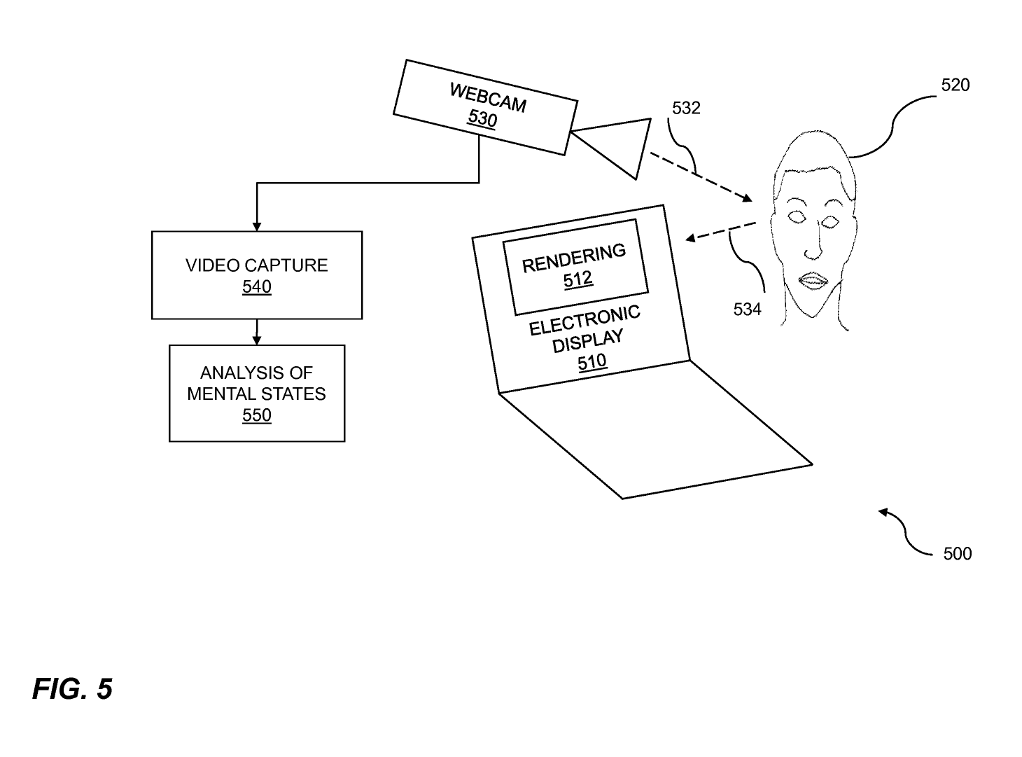

FIG. 5 is a diagram for capturing facial response to a rendering. In system 500, an electronic display 510 may show a rendering 512 to a person 520 in order to collect facial data and/or other indications of mental state. A webcam 530 is used to capture one or more of the facial data and the physiological data. The facial data may include information on facial expressions, action units, head gestures, smiles, brow furrows, squints, lowered eyebrows, raised eyebrows, or attention in various embodiments. The webcam 530 may capture video, audio, and/or still images of the person 520. A webcam, as the term is used herein and in the claims, may be a video camera, still camera, thermal imager, CCD device, phone camera, three-dimensional camera, a depth camera, multiple webcams 530 used to show different views of the person 520 or any other type of image capture apparatus that may allow data captured to be used in an electronic system. The electronic display 510 may be any electronic display, including but not limited to, a computer display, a laptop screen, a net-book screen, a tablet computer, a cell phone display, a mobile device display, a remote with a display, or some other electronic display. The rendering 512 may be that of a web-enabled application and may include a landing page, a checkout page, a webpage, a website, a web-enabled application, a video on a web-enabled application, a game on a web-enabled application, a trailer, a movie, an advertisement, or a virtual world or some other output of a web-enabled application. The rendering 512 may also be a portion of what is displayed, such as a button, an advertisement, a banner ad, a drop down menu, and a data element on a web-enabled application or other portion of the display. In some embodiments the webcam 530 may observe 532 the person to collect facial data. The facial data may include information on action units, head gestures, smiles, brow furrows, squints, lowered eyebrows, raised eyebrows, and attention. Additionally, the eyes may be tracked to identify a portion of the rendering 512 on which they are focused. For the purposes of this disclosure and claims, the word “eyes” may refer to either one or both eyes of an individual, or to any combination of one or both eyes of individuals in a group. The eyes may move as the rendering 512 is observed 534 by the person 520. The images of the person 520 from the webcam 530 may be captured by a video capture unit 540. In some embodiments, video may be captured, while in others, a series of still images may be captured. The captured video or still images may be used in one or more analyses.

Analysis of action units, gestures, and mental states 550 may be accomplished using the captured images of the person 520. The action units may be used to identify smiles, frowns, and other facial indicators of mental states. The gestures, including head gestures, may indicate interest or curiosity. For example, a head gesture of moving toward the electronic display 510 may indicate increased interest or a desire for clarification. Based on the captured images, analysis of physiological data may be performed. Respiration, heart rate, heart rate variability, perspiration, temperature, and other physiological indicators of mental state can be observed by analyzing the images. So in various embodiments, a webcam is used to capture one or more of the facial data and the physiological data.

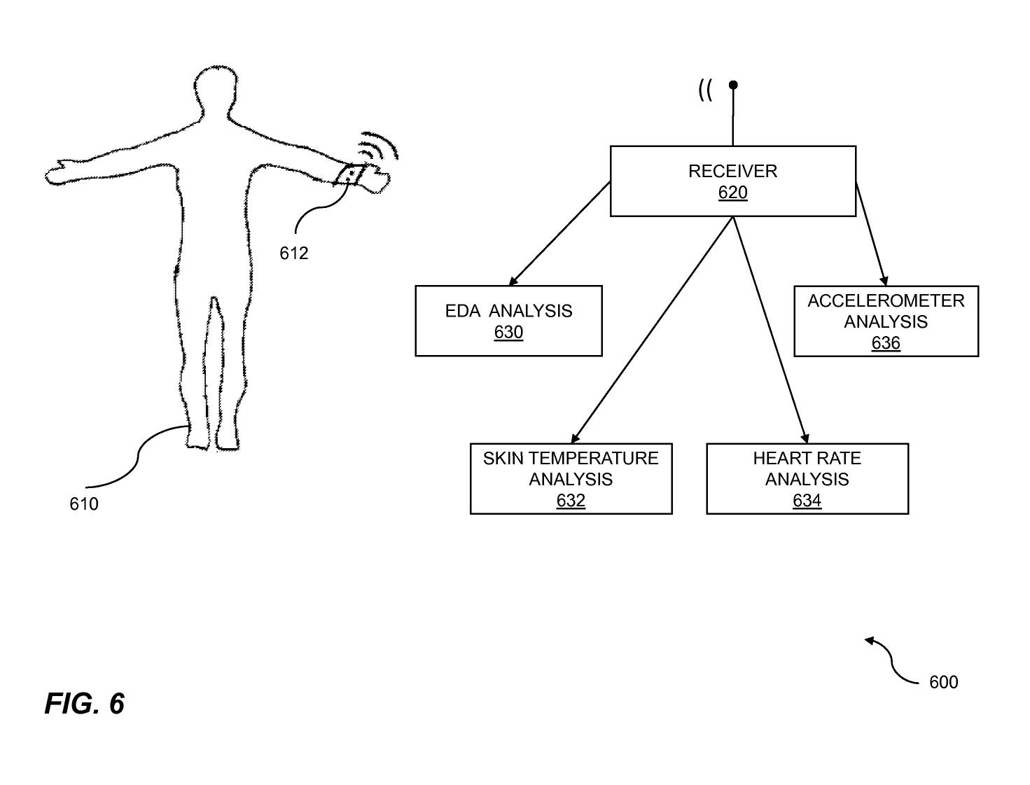

FIG. 6 is a diagram representing physiological analysis. A system 600 may analyze a person 610 for whom data is being collected. The person 610 may have a biosensor 612 attached to him or her so that the mental state data is collected using a biosensor 612. The biosensor 612 may be placed on the wrist, palm, hand, head, or other part of the body. In some embodiments, multiple biosensors may be placed on the body in multiple locations. The biosensor 612 may include detectors for physiological data, such as electrodermal activity, skin temperature, accelerometer readings and the like. Other detectors for physiological data may be included as well, such as heart rate, blood pressure, EKG, EEG, further brain waves, and other physiological detectors. The biosensor 612 may transmit information collected to a receiver 620 using wireless technology such as Wi-Fi, Bluetooth, 802.11, cellular, or other bands. In other embodiments, the biosensor 612 may communicate with the receiver 620 by other methods such as a wired interface, or an optical interface. The receiver may provide the data to one or more components in the system 600. In some embodiments, the biosensor 612 may record various physiological information in memory for later download and analysis. In some embodiments, the download of data the recorded physiological information may be accomplished through a USB port or other wired or wireless connection.

Mental states may be inferred based on physiological data, such as physiological data from the sensor 612. Mental states may also be inferred based on facial expressions and head gestures observed by a webcam or a combination of data from the webcam along with data from the sensor 612. The mental states may be analyzed based on arousal and valence. Arousal can range from being highly activated, such as when someone is agitated, to being entirely passive, such as when someone is bored. Valence can range from being very positive, such as when someone is happy, to being very negative, such when someone is angry. Physiological data may include electrodermal activity (EDA) or skin conductance or galvanic skin response (GSR), accelerometer readings, skin temperature, heart rate, heart rate variability, and other types of analysis of a human being. It will be understood that both here and elsewhere in this document, physiological information can be obtained either by biosensor 612 or by facial observation. Facial data may include facial actions and head gestures used to infer mental states. Further, the data may include information on hand gestures or body language and body movements such as visible fidgets. In some embodiments these movements may be captured by cameras or by sensor readings. Facial data may include the tilting the head to the side, leaning forward, a smile, a frown, as well as many other gestures or expressions.

Electrodermal activity may be collected in some embodiments and may be collected continuously, every second, four times per second, eight times per second, 32 times per second, or on some other periodic basis. The electrodermal activity may be recorded. The recording may be to a disk, a tape, onto flash memory, into a computer system, or streamed to a server. The electrodermal activity may be analyzed 630 to indicate arousal, excitement, boredom, or other mental states based on changes in skin conductance. Skin temperature may be collected on a periodic basis and may be recorded. The skin temperature may be analyzed 632 and may indicate arousal, excitement, boredom, or other mental states based on changes in skin temperature. The heart rate may be collected and recorded. The heart rate may be analyzed 634 and a high heart rate may indicate excitement, arousal or other mental states. Accelerometer data may be collected and indicate one, two, or three dimensions of motion. The accelerometer data may be recorded. The accelerometer data may be used to create an actigraph showing an individual's activity level over time. The accelerometer data may be analyzed 636 and may indicate a sleep pattern, a state of high activity, a state of lethargy, or other state based on accelerometer data. The various data collected by the biosensor 612 may be used along with the facial data captured by the webcam.

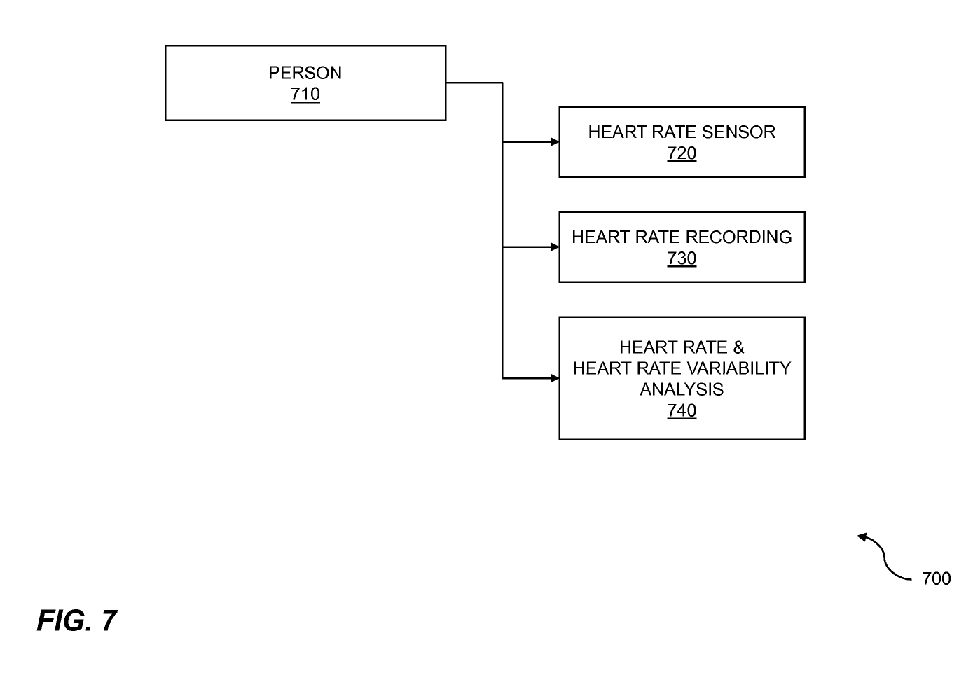

FIG. 7 is a diagram of heart related sensing. A person 710 is observed by system 700 which may include a heart rate sensor 720, a specific type of biosensor. The observation may be through a contact sensor or through video analysis, which enables capture of heart rate information, or other contactless sensing. In some embodiments, a webcam is used to capture the physiological data. In some embodiments, the physiological data is used to determine autonomic activity, and the autonomic activity may be one of a group comprising heart rate, respiration, and heart rate variability in some embodiments. Other embodiments may determine other autonomic activity such as pupil dilation or other autonomic activities. The heart rate may be recorded 730 to a disk, a tape, into flash memory, into a computer system, or streamed to a server. The heart rate and heart rate variability may be analyzed 740. An elevated heart rate may indicate excitement, nervousness, or other mental states. A lowered heart rate may indicate calmness, boredom, or other mental states. The level of heart-rate variability may be associated with fitness, calmness, stress, and age. The heart-rate variability may be used to help infer the mental state. High heart-rate variability may indicate good health and lack of stress. Low heart-rate variability may indicate an elevated level of stress. Thus, physiological data my include one or more of electrodermal activity, heart rate, heart rate variability, skin temperature, and respiration.

FIG. 8 is a graphical representation of mental state analysis. A window 800 may be shown which includes, for example, rendering of the web-enabled application 810 having associated mental state information. The rendering in the example shown is a video but may be any other sort of rendering in other embodiments. A user may be able to select between a plurality of renderings using various buttons and/or tabs such as Select Video 1 button 820, Select Video 2 button 822, Select Video 3 button 824, and Select Video 4 button 826. Various embodiments may have any number of selections available for the user and some may be other types of renderings instead of video. A set of thumbnail images for the selected rendering, that in the example shown include thumbnail 1 830, thumbnail 2 832, through thumbnail N 836, may be shown below the rendering along with a timeline 838. Some embodiments may not include thumbnails, or have a single thumbnail associated with the rendering, and various embodiments may have thumbnails of equal length while others may have thumbnails of differing lengths. In some embodiments, the start and/or end of the thumbnails may be determined by the editing cuts of the video of the rendering while other embodiments may determine a start and/or end of the thumbnails based on changes in the captured mental states associated with the rendering. In embodiments, thumbnails of the person on whom mental state analysis is being performed may be displayed.

Some embodiments may include the ability for a user to select a particular type of mental state information for display using various buttons or other selection methods. In the example shown, the smile mental state information is shown as the user may have previously selected the Smile button 840. Other types of mental state information that may be available for user selection in various embodiments may include the Lowered Eyebrows button 842, Eyebrow Raise button 844, Attention button 846, Valence Score button 848 or other types of mental state information, depending on the embodiment. The mental state information displayed may be based on physiological data, facial data, and actigraphy data. An Overview button 849 may be available to allow a user to show graphs of the multiple types of mental state information simultaneously.

Because the Smile option 840 has been selected in the example shown, smile graph 850 may be shown against a baseline 852 showing the aggregated smile mental state information of the plurality of individuals from whom mental state data was collected for the rendering 810. Male smile graph 854 and female smile graph 856 may be shown so that the visual representation displays the aggregated mental state information on a demographic basis. The various demographic based graphs may be indicated using various line types as shown or may be indicated using color or other method of differentiation. A slider 858 may allow a user to select a particular time of the timeline and show the value of the chosen mental state for that particular time. The slider may show the same line type or color as the demographic group whose value is shown.

Various types of demographic based mental state information may be selected using the demographic button 860 in some embodiments. Such demographics may include gender, age, race, income level, or any other type of demographic including dividing the respondents into those respondents that had a higher reaction from those with lower reactions. A graph legend 862 may be displayed indicating the various demographic groups, the line type or color for each group, the percentage of total respondents and or absolute number of respondents for each group, and/or other information about the demographic groups. The mental state information may be aggregated according to the demographic type selected.

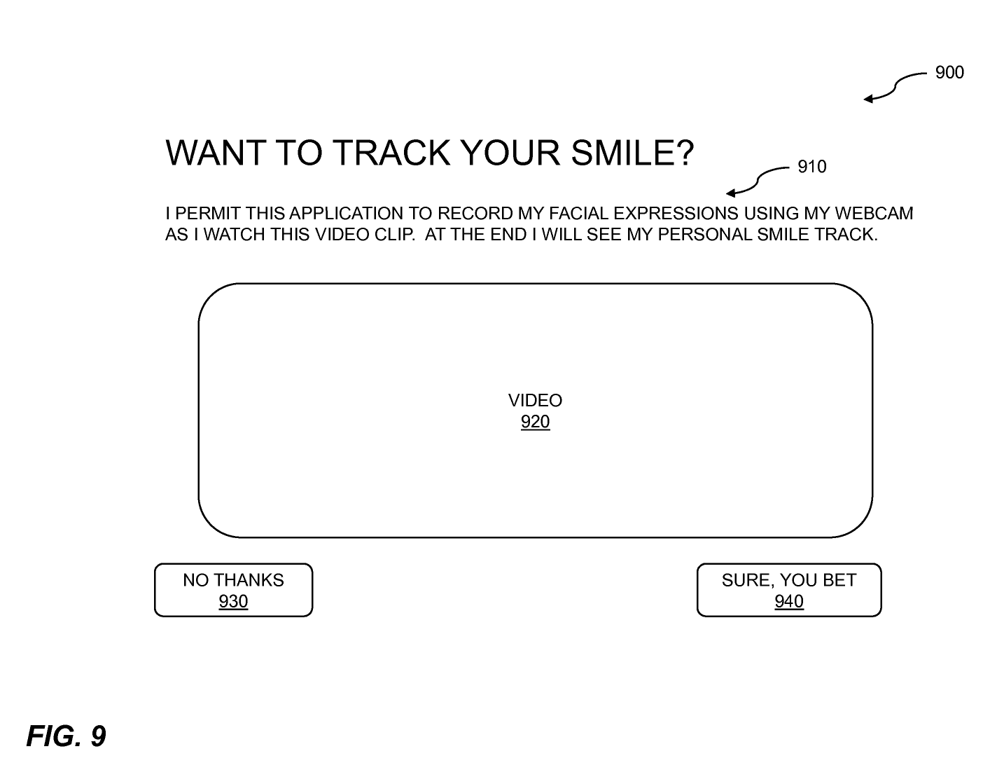

FIG. 9 is a diagram of a web page to elect sharing. A rendering 900 from a web-enabled application may present an individual with an option to collect mental state information. Flash™ may be used in some implementations to present and/or ask for permission. Various embodiments may use different language to ask the individual for their permission. In the embodiment shown, text 910 representing an individual's permission for the web-enabled application to record facial expressions is presented to the individual. A video 920 may be displayed to the individual. The video 920 may be the video from the individual's webcam, content that the individual will react to, a message asking the individual's permission, or any other video. Some embodiments may not include video but only include text or include text and images. The individual may respond to the invitation by clicking one of at least two buttons. If the individual does not want to be recorded and share their mental state information, the individual may click on the “No Thanks” button 930, and no mental state information will be captured of the individual. If the individual wants to be recorded and share their mental state information, the individual may click on the “Sure, You Bet” button 940 to initiate capture of their mental state information. Various embodiments may use other language for the buttons and some embodiments may include more than 2 options, such as including an option to share mental state information only with a specific group, capture facial data but don't share the mental state information until the individual has reviewed the mental state information, or various other restrictions on the mental state information. So sharing the mental state information may include electing, by the individual, to share the mental state information.

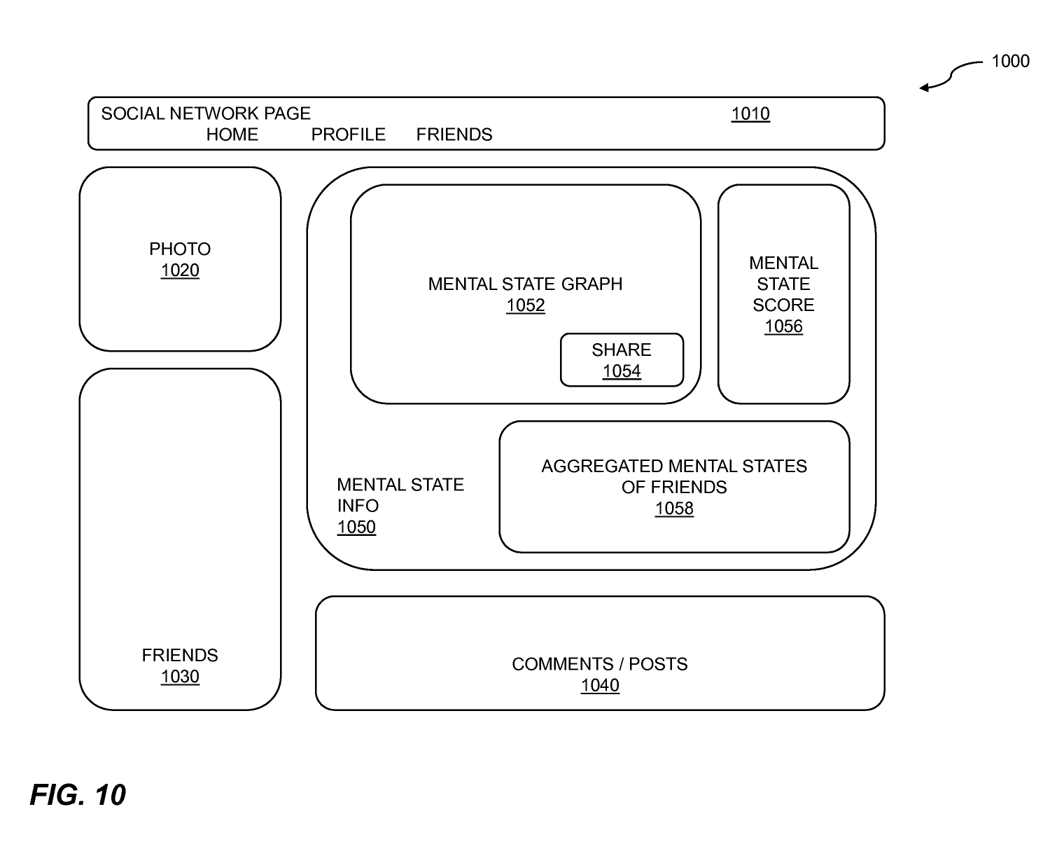

FIG. 10 is an example social network page content 1000. The exact content and formatting may vary between various social networks but similar content may be formatted for a variety of social networks including, but not limited to, a blogging website, Facebook™, LinkedIn™, MySpace™, Twitter™, Google+™, or any other social network. A social network page for a particular social network may include one or more of the components shown in the social network page content 1000, but may include various other components in place of, or in addition to, the components shown. The social network content 1000 may include a header 1010 that may identify the social network and may include various tabs or buttons for navigating the social network site, such as the “HOME,” “PROFILE,” and “FRIENDS” tabs shown. The social network content 1000 may also include a profile photo 1020 of the individual that owns the social network content 1000. Various embodiments may include a friends list 1030 showing the contacts of the individual on the particular social network. Some embodiments may include a comments component 1040 to show posts from the individual, friends, or other parties.

The social network content 1000 may include mental state information section 1050. The mental state information section 1050 may allow for posting mental state information to a social network web page. It may include mental state information that has been shared by the individual or may include mental state information that has been captured but not yet shared, depending on the embodiment. In at least one embodiment, a mental state graph 1052 may be displayed to the individual showing their mental state information while viewing a web-enabled application, such as the graph of FIG. 2. If the information has not yet been shared over the social network, a share button 1054 may be included in some embodiments. If the individual clicks on the share button 1054, mental state information, such as the mental state graph 1052 or various summaries of the mental state information, may be shared over the social network. The mental state information may be shared with an individual, a group or subgroup of contacts or friends, another group defined by the social network, or may be open to anyone, depending on the embodiment and a selection of the individual. The photo 1020, or another image shown on the social network, may be updated with an image of the individual with the mental state information that is being shared, such as a smiling picture if the mental state information is happy. In some cases, the image of the individual is from a peak time of mental state activity. In some embodiments, the photo 1020 section, or some other section of the social network page content 1000, may allow for video and the image includes a video of the individual's reaction or representing the mental state information. If the mental state information shared is related to a web-enabled application, forwarding a reference to the web-enabled application as a part of the sharing of the mental state information may be done and may include a URL and a timestamp which may indicate a specific point in a video. Other embodiments may include an image of material from the web-enabled application or a video of material from the web-enabled application. The forwarding, or sharing, of the various mental state information and related items may be done on a single social network, or some items may be forwarded on one social network while other items are forwarded on another social network. In some embodiments, the sharing is part of a rating system for the web-enabled application, such as aggregating mental state information from a plurality of users to automatically generate a rating for videos.

Some embodiments may include a mental state score 1056. In some embodiments, the mental state data is collected over a period of time and the mental state information that is shared is a reflection of a mood for the individual in a mental state score 1056. The mental state score may be a number, a sliding scale, a colored scale, various icons or images representing moods or any other type of representation. In some embodiments, the mental state score 1056 may emulate a “mood ring” as was popular back in the 1970's. Various moods may be represented, including, but not limited to, frustration, confusion, disappointment, hesitation, cognitive overload, focusing, being engaged, attending, boredom, exploration, confidence, trust, delight, and satisfaction.

Some embodiments may include a section for aggregated mental states of friends 1058. This section may include an aggregated mood of those friends shown in the friends section 1030 that have opted to share their mental state information. Other embodiments may include aggregated mental states of those friends that have viewed the same web-enabled application as the individual and may allow the individual to compare their mental state information in the mental state graph 1052 to their friends' mental state information 1058. Other embodiments may display various aggregations of different groups.

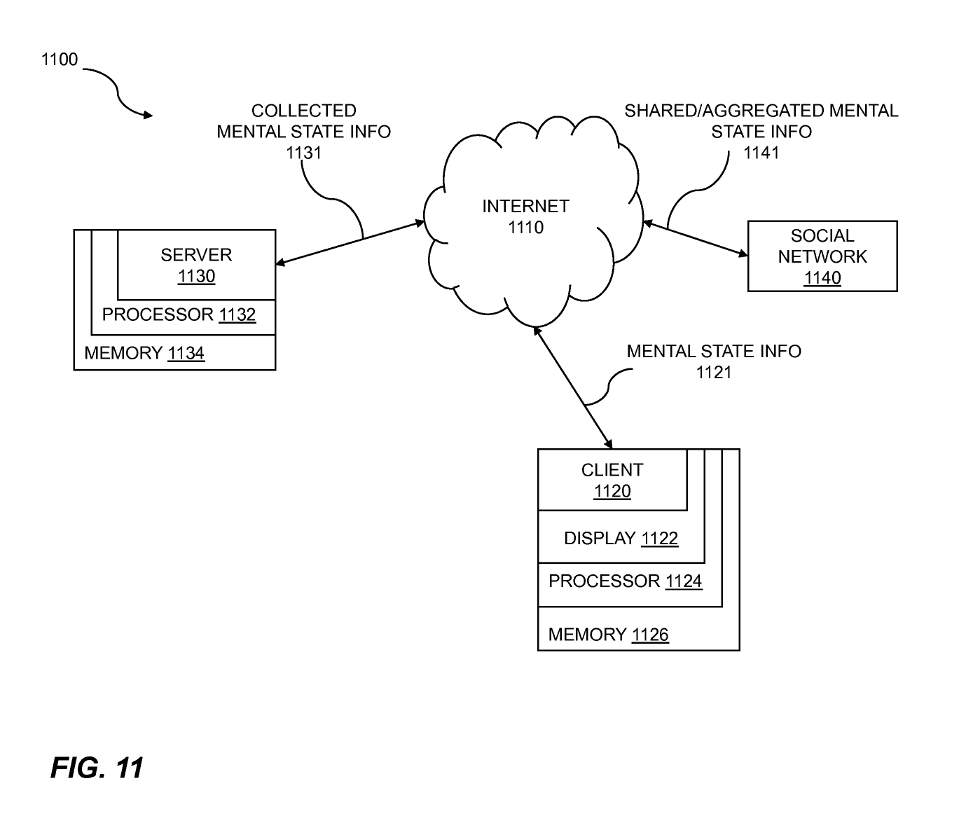

FIG. 11 is a system diagram 1100 for sharing across a social network, or a system for sharing mental states. The internet 1110, intranet, or other computer network may be used for communication between the various computers. A client computer 1120 has a memory 1126 for storing instructions and one or more processors 1124 attached to the memory 1126 wherein the one or more processors 1124 can execute instructions. The client computer 1120 also may have an internet connection to carry mental state information 1121 and a display 1122 that may present various renderings to a user. The client computer 1120 may be able to collect mental state data from an individual or a plurality of people as they interact with a rendering. In some embodiments, there may be multiple client computers 1120 that each may collect mental state data from one person or a plurality of people as they interact with a rendering. In other embodiments, the client computer 1120 may receive mental state data collected from a plurality of people as they interact with a rendering. The client computer 1120 may receive an instruction, from the individual, to elect to share the mental state information. Once the mental state data has been collected, the client computer may, if permission is received, upload information to a server 1130, based on the mental state data from the plurality of people who interact with the rendering. The client computer 1120 may communicate with the server 1130 over the internet 1110, some other computer network, or by other method suitable for communication between two computers. In some embodiments, the server 1130 functionality may be embodied in the client computer.

The server 1130 may have an internet connection for receiving mental states or collected mental state information 1131 and have a memory 1134 which stores instructions and one or more processors 1132 attached to the memory 1134 to execute instructions. The server 1130 may receive mental state information collected from a plurality of people as they interact with a rendering from the client computer 1120 or computers, and may analyze the mental state data to produce mental state information. The server 1130 may also aggregate mental state information on the plurality of people who interact with the rendering. The server 1130 may also associate the aggregated mental state information with the rendering and also with the collection of norms for the context being measured. In some embodiments the server 1130 may also allow user to view and evaluate the mental state information that is associated with the rendering, but in other embodiments, the server 1130 may send the aggregated mental state information 1141 to a social network 1140 to be shared, distributing the mental state information across a computer network. This may be done to share the mental state information across a social network. In some embodiments the social network 1140 may run on the server 1130.

Each of the above methods may be executed on one or more processors on one or more computer systems. Embodiments may include various forms of distributed computing, client/server computing, and cloud based computing. Further, it will be understood that for each flow chart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, and so on. Any and all of which may be generally referred to herein as a “circuit,” “module,” or “system.”

A programmable apparatus which executes any of the above mentioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM, Flash, MRAM, FeRAM, or phase change memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

1. A computer implemented method for communicating mental states comprising:
collecting mental state data of an individual;
analyzing the mental state data to produce mental state information; and
sharing the mental state information across a social network.

2. The method of claim 1 further comprising electing, by the individual, to share the mental state information.

3. The method according to claim 2 further comprising presenting the mental state information to the individual, prior to the electing.

4. The method of claim 1 wherein the mental state data is collected over a period of time and the mental state information that is shared is a reflection of a mood for the individual.

5. The method of claim 4 wherein the mood includes one of a group comprising frustration, confusion, disappointment, hesitation, cognitive overload, focusing, being engaged, attending, boredom, exploration, confidence, trust, delight, and satisfaction.

6-7. (canceled)

8. The method of claim 1 further comprising distributing the mental state information across a computer network.

9. The method of claim 1 wherein the mental state data includes one of a group comprising physiological data, facial data, and actigraphy data.

10. The method of claim 9 wherein a webcam is used to capture one or more of the facial data and the physiological data.

11. The method of claim 9 wherein the facial data includes information on one or more of a group comprising facial expressions, action units, head gestures, smiles, brow furrows, squints, lowered eyebrows, raised eyebrows, and attention.

12. The method of claim 9 wherein the physiological data includes one or more of electrodermal activity, heart rate, heart rate variability, skin temperature, and respiration.

13. The method of claim 1 further comprising inferring of mental states based on the mental state data which was collected.

14. The method of claim 13 further comprising identifying similar mental states within the social network.

15-18. (canceled)

19. The method of claim 1 further comprising restricting distribution of the mental state information to a subset of the social network.

20. (canceled)

21. The method according to claim 1 wherein the mental state data is collected as the individual interacts with a web-enabled application.

22. The method according to claim 21 wherein the web-enabled application is one of a group comprising a landing page, a checkout page, a webpage, a website, a video on the web-enabled application, a game on the web-enabled application, a trailer, a movie, an advertisement, and a virtual world.

23. The method according to claim 21 further comprising forwarding a reference to the web-enabled application as a part of the sharing of the mental state information.

24. The method of claim 23 wherein the reference includes a URL and a timestamp.

25. The method of claim 23 wherein the forwarding includes an image of material from the web-enabled application.

26. The method of claim 23 wherein the forwarding includes a video of material from the web-enabled application.

27-28. (canceled)

29. A computer program product embodied in a non-transitory computer readable medium for communicating mental states, the computer program product comprising:
code for collecting mental state data of an individual;
code for analyzing the mental state data to produce mental state information;
code for electing, by the individual, to share the mental state information; and
code for sharing the mental state information across a social network.

30. A system for sharing mental states comprising:
a memory for storing instructions;
one or more processors attached to the memory wherein the one or more processors are configured to:
collect mental state data of an individual;
analyze the mental state data to produce mental state information;
receive an instruction, from the individual, to elect to share the mental state information; and
share the mental state information across a social network.

31. (canceled)
